(19) United States
(12) Patent Application Publication
(10) Pub. No.: US 2015/0258994 A1
(43) Pub. Date: Sep. 17, 2015

(54) VEHICLE WITH MASS AND GRADE RESPONSIVE CRUISE CONTROL

(71) Applicant: FORD GLOBAL TECHNOLOGIES, LLC, Dearborn, MI (US)

(72) Inventors: Narayanan Kidambi, Ann Arbor, MI (US); Yuji Fujii, Ann Arbor, MI (US); Gregory Michael Pietron, Canton, MI (US)

(73) Assignee: FORD GLOBAL TECHNOLOGIES, LLC, Dearborn, MI (US)

(21) Appl. No.: 14/215,812

(22) Filed: Mar. 17, 2014

(51) Int. Cl. B60W 30/16; B60W 10/04; B60W 30/188; B60W 10/10; B60W 30/18; B60W 40/076; B60W 10/02

(52) U.S. Cl. CPC B60W 30/16; B60W 40/076; B60W 10/04; B60W 10/023; B60W 10/10; B60W 30/18172; B60W 30/188

(57) ABSTRACT

A vehicle controller estimates the turbine torque based on measured impeller and turbine speeds. Then, it estimates the tractive force based on gear ratios, tire sizes, and estimates of parasitic losses. The controller estimates the current grade based on a difference between an acceleration sensor reading and the derivative of a measured vehicle speed. Then, it estimates the current vehicle weight based on the tractive force, the acceleration rate, and the grade. The controller adjust a target following distance of a cruise control system based on the estimate of the weight and the grade. The cruise control system adjusts power to maintain a measured following distance equal to the target following distance.

### TECHNICAL FIELD

This disclosure relates to the field of vehicle controls. More particularly, the disclosure pertains to a cruise control system that responds to changes in vehicle mass and grade.

### BACKGROUND

To ease driver workload and improve fuel economy, many vehicles are equipped with a cruise control feature. When a driver activates the cruise control, a controller actively adjusts the power level in order to maintain a target speed. When the speed decreases below the target speed, such as may occur when ascending a hill, the controller increases the power level in order to increase the speed. On the other hand, when the speed increases above the target level, the controller decreases the power level. When other vehicles are present, the driver must occasionally intervene in order to ensure that the vehicle does not get too close to the vehicle ahead. Driver workload would be further reduced, and safety improved, if the cruise control feature automatically modified the power level in order to maintain an appropriate following distance. The following distance should be large enough such that, if the vehicle ahead stops quickly, the driver can stop before impacting the vehicle ahead.

### SUMMARY OF THE DISCLOSURE

A vehicle includes an engine and a controller programmed to adjust engine power to maintain a following distance. The current following distance may be determined using a range sensor. The following distance is adjusted in response to a change in the mass of the vehicle. The target following distance may also be adjusted in response to a change in the current road grade. The current road grade may be calculated by comparing the reading from an acceleration sensor and the derivative of a measured vehicle speed. The mass may be estimated based on an estimate of the tractive force, the vehicle acceleration rate, and the current grade. The tractive force may be estimated based on an estimate of the turbine torque, a transmission gear ratio, a final drive ratio, and a tire radius. The turbine torque may be estimated based on measurements of impeller and turbine speeds. The tractive force may be adjusted based on estimates of parasitic losses.

A method of operating a vehicle includes periodically measuring a distance between the vehicle and another vehicle, adjusting a power setting to maintain the distance equal to a target following distance, and adjusting the target following distance based on a change in the relationship between impeller speed, turbine speed, and vehicle acceleration. Vehicle acceleration may be determined by reading an acceleration sensor, taking a derivative of a reading of a speed sensor, or a combination of these methods.

### BRIEF DESCRIPTION OF THE DRAWINGS

FIG. 1 is a schematic representation of a vehicle with a mass and grade responsive cruise control system.

FIG. 2 is a flow chart for a method of controlling engine power to maintain both a target speed and a target following distance that is responsive to mass and grade.

FIG. 3 is a flow chart for a method of estimating the tractive force based on measurements of impeller speed and turbine speed while a torque converter is open.

FIG. 4 is a free body diagram of a vehicle ascending a hill.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

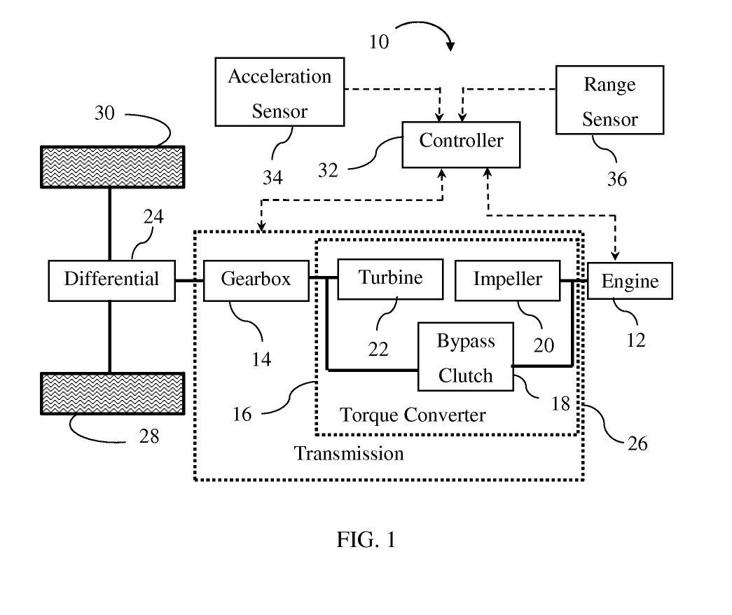

A vehicle 10 with a cruise control system is illustrated schematically in FIG. 1. Power to propel the vehicle is provided by internal combustion engine 12. The power is transmitted to gearbox 14 by torque converter 16. Torque converter 16 provides two alternative power flow paths. When bypass clutch 18 is engaged, it transmits the power. When bypass clutch 18 is open, power is transferred hydro-dynamically through impeller 20 and turbine 22. The turbine torque is a function of the speed of the impeller and the speed of the turbine. Power is transferred from the impeller to the turbine only when the impeller rotates faster than the impeller. When the ratio of impeller speed to turbine speed is high enough, the turbine torque is a multiple of the impeller torque. Gearbox 14 transmits power from torque converter to differential 24 at various speed ratios. At low vehicle speeds, the gearbox multiplies the turbine torque. At high vehicle speeds, the gearbox may use an overdrive ratio that increases speed and decreases torque. Torque converter 16, gearbox 14, and associated controls collectively form transmission 26. Differential 24 further multiplies the torque by a fixed ratio and changes the axis of rotation by 90 degrees. Differential 24 transmits approximately equal torques to left and right wheels 28 and 30 while accommodating slight speed differences between the wheels as the vehicle turns. Wheels 28 and 30 convert the torque into a tractive force against the road surface. The magnitude of the tractive force is directly proportional to the torque and inversely proportional to the radius of the wheel. Although FIG. 1 illustrated a longitudinal powertrain, the powertrain may also be mounted transversely, in which case the axis of rotation of the engine and transmission is parallel to, but offset from, the wheel axis.

Controller 32 sends signals to engine 12 to control the amount of power produced. These signals may impact, for example, the fuel flow, the throttle opening, and spark timing. Controller 32 also receives signals from engine 12 such as crankshaft speed. Controller 32 also sends signals to transmission 26 to control the state of engagement or release of bypass clutch 18 and various clutches and brakes within gearbox 14. Alternatively, transmission 26 may be a continuously variable transmission (CVT) in which gearbox 14 is a variator and signals from controller 32 control the variator ratio. Controller 32 receives signals from transmission 26 such as turbine speed and driveshaft speed. Controller 32 also receives signals from acceleration sensor 34, range sensor 36, and driver activated controls such as the accelerator pedal, brake pedal, and transmission range sensor (PRNDL). Controller 32 may be implemented as a single controller or as multiple communicating controllers.

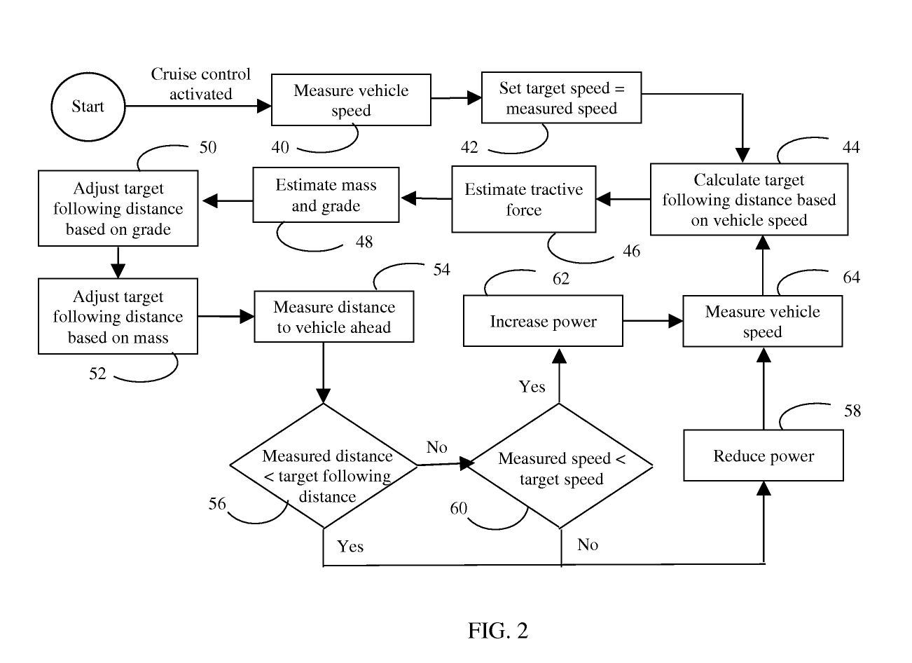

When the driver activates the cruise control feature, the controller executes the method illustrated in FIG. 2. The controller measures vehicle speed at 40. Vehicle speed may be measured, for example, by measuring the speed of the driveshaft and multiplying by the known final drive ratio of the differential and the known wheel radius. The measured speed at the time the cruise control feature is activated is set as the target speed at 42. In some embodiments, driver interface features may be provided to adjust the target speed.

At 44, a target following distance is calculated based on vehicle speed. For example, the target following distance may be proportional to vehicle speed, may be a more complex function of vehicle speed, or may be determined by a table lookup. At 46, tractive force is estimated, as described in detail below. At 48, the current vehicle mass and the current grade are estimated, as described in detail below. At 50 and 52, the target following distance is adjusted based on the current grade and the current vehicle mass, respectively. When the vehicle is going downhill, the target following distance may be increased to account for the fact that gravity would reduce the deceleration rate achievable if hard braking were suddenly required. Therefore, target following distance is increased on downhill grades. The increase may be in proportion to the current grade or may be non-linearly related. The grade adjustment may depend on the current vehicle speed. Similarly, when the vehicle is heavily loaded, the distance required to slow down may increase. Therefore, the target following distance may be increased when the estimated vehicle mass is above a threshold. The increase may be non-linear and may differ depending on vehicle speed and current grade.

At 54, the distance to another vehicle ahead is measured using range sensor 36. A large distance may be used as a default value when no vehicle is present in the same lane. At 56, this measured distance is compared to the target following distance. If the measured distance is less than the target following distance, the commanded power level from the engine is reduced at 58. In some embodiments, if the power level is already at idle, the brakes may be applied. Some embodiments may also consider the rate of change of the measured distance. If the measured distance is greater than the target following distance, then the controller compares the measured speed to the target speed at 60. If the measured speed is less than the target speed, then the controller commands an increase in power from the engine at 62. On the other hand, if the measured speed is greater than the target speed, the controller commands a decrease in power at 58. Some embodiments may also consider the rate of change of the measured speed. In either case, a revised speed measurement is taken at 64 and the process repeats.

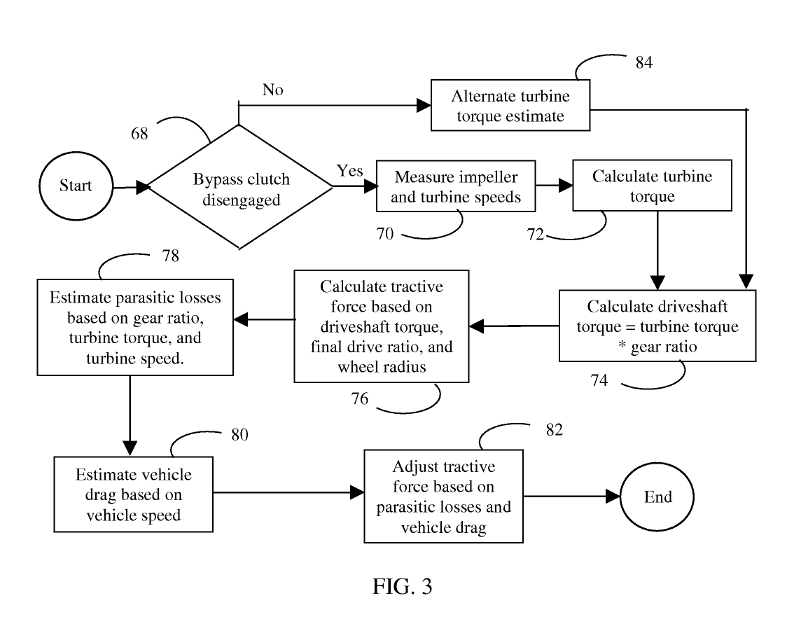

FIG. 3 illustrates a process for estimating the tractive force. For a given torque converter geometry, the hydrodynamic torque on the turbine is primarily a function of the impeller speed and the turbine speed. Other factors have relatively weak impact. Therefore, when bypass clutch 18 is disengaged, as determined at 68, the turbine torque is estimated by measuring impeller speed and turbine speed at 70 and then calculating turbine torque at 72. The controller can determine the impeller speed from the crankshaft speed. If the transmission is equipped with a turbine speed sensor, the turbine speed can be determined directly. If the transmission does not have a turbine speed sensor, turbine speed may be determined from other speed measurements, such as driveshaft speed, whenever the gearbox is engaged at a known speed ratio. The controller may store a table of turbine torque as a function of impeller speed and turbine speed and estimate turbine torque using a simple two dimensional table lookup with interpolation. However, due to the non-linear nature of the relationship, it may be more accurate to tabulate the data as a function of different independent variables. For example, the controller might calculate the ratio of the speeds and the difference of the speeds and perform a table lookup based on these two values. Alternatively, the turbine torque may be calculated from a capacity factor and a torque ratio each of which are determined with a one dimensional table lookup based on the speed ratio. The impeller torque is equal to the square of the ratio of the impeller speed to the capacity factor. The turbine torque is equal to the impeller torque multiplied by the torque ratio.

Once turbine torque is estimated, driveshaft torque is calculated by multiplying by the current gear ratio at 74. Similarly, tractive force is calculated at 76 by multiplying the driveshaft torque by the fixed final drive ratio and the fixed tire radius. The actual tractive force will likely be less than this calculated value due to parasitic losses in the transmission and driveline. Some of these parasitic losses, such as drag caused by open clutches are primarily dependent on the speeds of various components. Other parasitic losses, such as gear mesh losses, are primarily dependent on the torque level. The parasitic losses can vary significantly between different gearbox gear ratios. At 78, the parasitic losses are estimated using a table lookup or other model based on gear ratio, turbine torque, and turbine speed. Some models may include adjustments for other factors such as temperature. Some of the tractive force is used to overcome vehicle drag. The drag is estimated at 80 based on vehicle speed. Finally, at 82, the tractive force calculated at 76 is adjusted by subtracting the parasitic losses estimated at 78 and the vehicle drag estimated at 80, yielding the tractive force that is devoted to climbing the grade and accelerating the vehicle.

When bypass clutch 18 is engaged, some other method must be employed to calculate the turbine torque at 84. For example, the controller may calculate an estimate of the torque produced by the engine as a function of engine speed, fuel flow, air flow, and spark timing. When bypass clutch 18 is disengaged, the impeller torque calculated as described above can be compared to the controller's estimate of engine torque and the engine torque model can be dynamically refined to be more accurate.

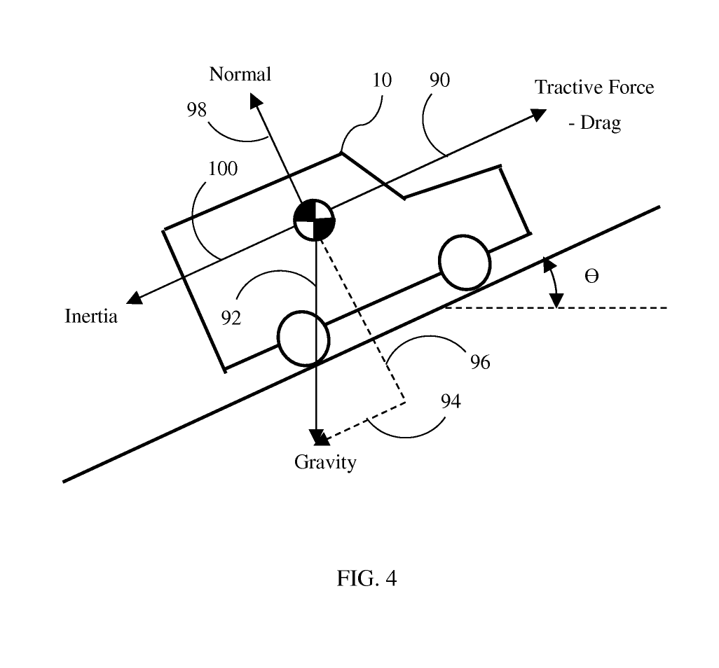

FIG. 4 shows a free body diagram of vehicle 10 as it ascends a hill with a grade θ. The tractive force corrected for vehicle drag F as estimated above is represented by vector 90. This force acts to accelerate vehicle 10 up the hill. The force of gravity, which acts vertically, is represented by vector 92. The magnitude of the gravitational force is equal to the vehicle mass m multiplied by the gravitational constant g. The gravitational force can be divided into two components: a component 94 acting to slow the vehicle down and a component 96 acting to pull the vehicle toward the road. The magnitude of component 94 is equal to mg sin(θ). Component 96 is reacted by the road with a normal force represented by vector 98. These forces result in a net acceleration α=∂ν/∂t where ν is the velocity. Vector 100 represents the inertia of the vehicle which has a magnitude of mα. Movement up the hill is governed by the equation:

F=mα+mg sin(θ)=m (α+g sin(θ)).

Accelerometer 34 directly measures α+g sin(θ). Therefore, the mass m is calculated by dividing the corrected tractive force F by the accelerometer reading r. Mathematically,

m=F/r.

The acceleration rate α can be determined by numerically differentiating the vehicle speed ν. Then, the gradient can be calculated using the formula:

sin(θ)=(r−α)/g.

In the absence of accelerometer 34, other methods are available to estimate the mass m and the grade angle θ using a series of measurements of a and estimates of F over a period of time. These methods assume that vehicle mass changes very slowly relative to changes in grade. Alternatively, if grade can be determined from some other source, such as a GPS database, then mass can be determined from the above formulas.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
an engine configured to generate mechanical power to propel the vehicle; and
a controller programmed to adjust the power to maintain a distance between the vehicle and another vehicle substantially equal to a target following distance and to alter the target following distance in response to a change in a mass of the vehicle.

2. The vehicle of claim 1 wherein the controller is further programmed to alter the target following distance in response to a change in a current road grade.

3. The vehicle of claim 2 wherein the controller is further programmed to estimate the current road grade based on a difference between an acceleration sensor reading and a derivative of a vehicle speed.

4. The vehicle of claim 1 further comprising:
a torque converter having an impeller driveably connected to the engine and a turbine; and
wherein the controller is further programmed to estimate a turbine torque based on an impeller speed and a turbine speed.

5. The vehicle of claim 4 further comprising:
a gearbox configured to establish a first power flow path from the turbine to an output shaft, the first power flow path having a gear ratio between the turbine and an output shaft;
a driveline configured to establish a second power flow path from the output shaft and at least one wheel, the second power flow path having a final drive ratio; and
wherein the controller is further programmed to estimate a tractive force based on the turbine torque, the gear ratio, the final drive ratio, and the wheel radius.

6. The vehicle of claim 5 wherein the controller is further programmed to adjust the estimated tractive force based on a model of parasitic losses in the gearbox and the driveline.

7. The vehicle of claim 5 wherein the controller is further programmed to adjust the estimated tractive force based on an estimate of a force required to overcome vehicle parasitic drag.

8. The vehicle of claim 5 wherein the controller is further programmed to estimate the mass by computing a ratio of estimated tractive force to a measured acceleration.

9. A vehicle comprising:
an engine configured to generate mechanical power to propel the vehicle;
a range sensor configured to measure a distance between the vehicle and another vehicle; and
a controller programmed to adjust the power to maintain the distance substantially equal to a target following distance and to alter the target following distance in response to a change in a current road grade.

10. The vehicle of claim 9 further comprising:
an acceleration sensor;
a speed sensor configured to measure a speed proportional to a vehicle speed; and
wherein the controller is further programmed to estimate the current road grade based on a difference between the acceleration sensor reading and a derivative of the vehicle speed.

11. A method of operating a vehicle comprising:
periodically measuring a distance between the vehicle and another vehicle, a vehicle acceleration, an impeller speed, and a turbine speed;
adjusting a power setting to maintain the distance substantially equal to a target following distance; and
altering the target following distance in response to a change in a relationship among impeller speed, turbine speed, and vehicle acceleration indicative of a change in vehicle mass or road grade.

12. The method of claim 11 wherein periodically measuring the vehicle acceleration comprises periodically reading an acceleration sensor.

13. The method of claim 11 wherein periodically measuring the vehicle acceleration comprises:
periodically reading a speed sensor; and
computing a difference between speed sensor readings taken at different times.

14. The method of claim 13 further comprising periodically reading an acceleration sensor.
